(19) United States
(12) Patent Application Publication
(10) Pub. No.: US 2010/0083706 A1
(43) Pub. Date: Apr. 8, 2010

(54) Lithium silicate glass ceramic for fabrication of dental appliances

(75) Inventor: Rodolfo Castillo, Boca Raton, FL (US)

Correspondence Address: LEONARD TACHNER, A PROFESSIONAL LAW;CORPORATION, 17961 SKY PARK CIRCLE, SUITE 38-E, IRVINE, CA, 92614, US

(73) Assignee: James R., Glidewell Dental Ceramics, Inc.

(21) Appl. No.: 12/592,825

(22) Filed: Dec. 3, 2009

Related U.S. Application Data
(63) Continuation-in-part of application No. 12/283,472, filed on Sep. 12, 2008.
Application No. 12/283,472 is a continuation-in-part of application No. 12/082,576, filed on Apr. 11, 2008.

(51) Int. Cl. C03B 18/00; C03C 3/118; C03C 3/083; C03C 3/097

(52) U.S. Cl. 65/66; 501/59; 501/68; 501/63

(57) ABSTRACT

The present invention relates to preparing an improved lithium silicate glass ceramic for the manufacture of blocks for dental appliance fabrication using a CAD/CAM process and hot pressing system. The lithium silicate material has a chemical composition that is different from those reported in the prior art with 1 to 10% of germanium dioxide in final composition. The softening points are close to the crystallization final temperature of 830° C. indicating that the samples will support the temperature process without shape deformation.

### RELATION TO CORRESPONDING APPLICATIONS

This application is a continuation-in-part of application Ser. No. 12/283,472 filed Sep. 12, 2008 which, in turn, is a continuation-in-part of application Ser. No. 12/082,576 filed Apr. 11, 2008.

### BACKGROUND OF THE INVENTION

1. Field of the Invention

The present invention relates to a lithium silicate glass ceramic material for the manufacturing of blocks and subsequent fabrication of single crowns with the aid of the CAD/CAM process and hot pressing. The invention relates to an improved version of such glass ceramic containing germanium dioxide to make it more castable with higher density than the lithium disilicate free of germanium dioxide and subsequently with higher flexural strength.

2. Background Art

There are many products available in the market employing lithium disilicate material and covered by several U.S. patents. Some of these patents claim a process for the preparation of shaped translucent lithium disilicate glass ceramic products from a mixture of basic components (SiO2, Al2O3, K2O, Li2O, plus pigments and fluorescent oxides). U.S. Pat. Nos. 6,517,623 and 6,455,451 describe a process for a lithium disilicate glass ceramic and require a step of comminuting the glass ceramic into a powder and then compacting the powder to a starting blank before sintering the blank or the restoration. U.S. Pat. No. 6,802,894 also describes a lithium disilicate glass ceramic material where the blanks follow the nucleation and crystallization stages and then a dental restoration is prepared by pressing the pellet.

U.S. Pat. Nos. 5,968,856 and 6,420,288 require the addition of lanthanum oxide on the lithium disilicate product to improve the flow properties, control the crystal growth and eliminate the strong reaction of the material with the investment material used. Other patents describe a process for the production of lithium disilicate glass ceramic where mixtures of basic components except lanthanum oxide are claimed in different ranges. A patent also describes a lithium disilicate preparation which uses zirconium, titanium dioxide and phosphorus as nucleation agents in their formulation. There are also some other patents, scientific papers and technical books describing the preparation methods of lithium disilicate glass ceramic. Most of them use similar composition ranges of the patents described above and the thermal cycles of nucleation and crystallization.

Most of the existing patents in the dental field use the same basic components. The present invention uses germanium dioxide as a fundamental part of the formula. This oxide is broadly used in glass preparation for its good optical properties. The oxide has been well studied and has positive effects compared to common silicon glasses. It has been found that the addition of germanium oxide produces a melt with low viscosity, which facilitates the castability of the process and increases the thermal expansion and the refractive index of the resulting lithium silicate glass ceramic. More importantly, the addition of germanium dioxide increases the final density of the glass, resulting in higher values of flexural strength than the lithium silicate glasses free of germanium dioxide. Because the final composition of this invention uses a molar ratio of Si/Li between 1.8 to 1.9, only the lithium silicate phase instead of lithium disilicate phase is present as a main constituent of the glass ceramic.

### SUMMARY OF THE INVENTION

The present invention relates to preparing an improved lithium silicate glass ceramic for the manufacture of blocks for dental appliance fabrication using a CAD/CAM process and hot pressing. The lithium silicate material has a chemical composition that is different from those reported in the prior art, especially because of the use of germanium dioxide and low silicon dioxide content. The softening points are close to the crystallization final temperature of 830° C. indicating that the samples will support the temperature process without shape deformation.

The initial components are chemical precursors, specifically aluminum hydroxide for aluminum oxide, lithium carbonate for lithium oxide, ammonium hydrogen phosphate or calcium phosphate for phosphorus pentoxide, zirconium silicate or yttrium stabilized zirconia for zirconium oxide, calcium carbonate for calcium oxide, lithium fluoride for lithium oxide and fluoride, and potassium carbonate for potassium oxide. The remaining elements are single oxide precursors of silicon, cerium, titanium, tin, erbium, vanadium, germanium, samarium, niobium, yttrium, europium, tantalum, magnesium, vanadium and manganese oxides.

The components are mixed for about 10 to 15 minutes in a blender. Then the mixture is put into an alumina jar ball mill using zirconia balls as a grinding media and ground for about one to two hours. This step is important for optimizing the blend of materials especially when the precursors used have different particle sizes. The ball mill process can be done wet or dry depending on the chemistry of precursors used. One embodiment uses 2-propanol, n-hexane and ethanol as solvents. Once the solvent is removed from the powder by filtration and evaporation, the powder is placed inside a platinum crucible and heated to a range of 1400° to 1500° C. for 1 to 5 hours. Then the melt is cast into square or cylindrical graphite molds and the resulting blocks are cooled down to room temperature. Because of the wet or dry mill process step, there is no need for a second re-melting process for improving homogeneity.

### BRIEF DESCRIPTION OF THE DRAWINGS

The aforementioned objects and advantages of the present invention, as well as additional objects and advantages thereof, will be more fully understood herein after as a result of a detailed description of a preferred embodiment when taken in conjunction with the following drawing in which:

FIG. 1 is a XRD diffraction pattern of a sample of this invention after full crystallization showing the presence of lithium silicate as a main constituent phase in the glass ceramic composition. Because the molar ratio of Si/Li is between of 1.8 to 1.9, the crystallized phase of the final material shows only the presence of lithium silicate instead of lithium disilicate; and

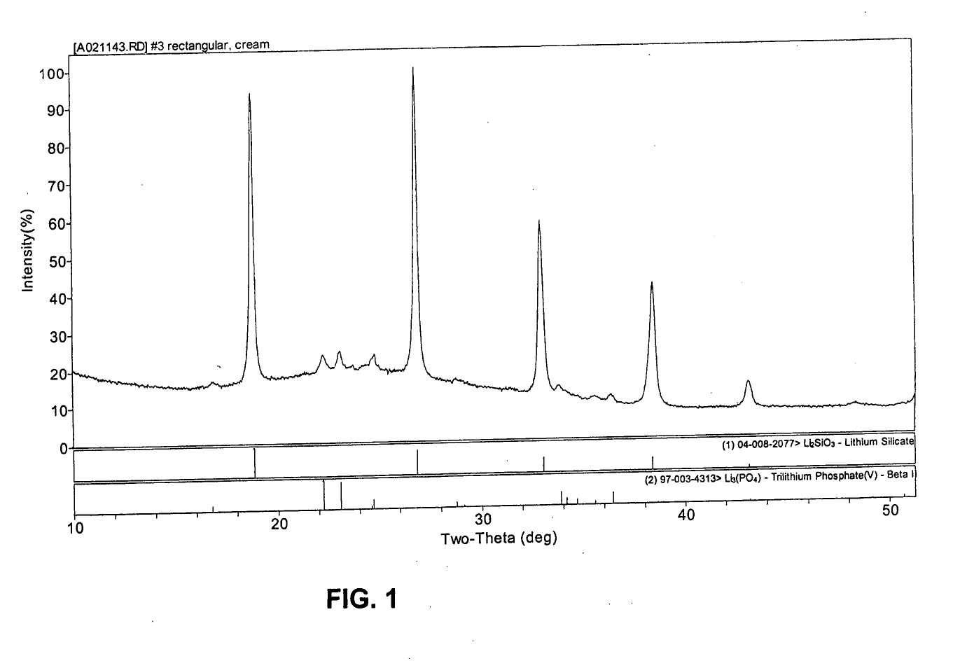

FIG. 2 is a graphical illustration of a dilatometric measurement of a sample of the invention resulting from full crystallization.

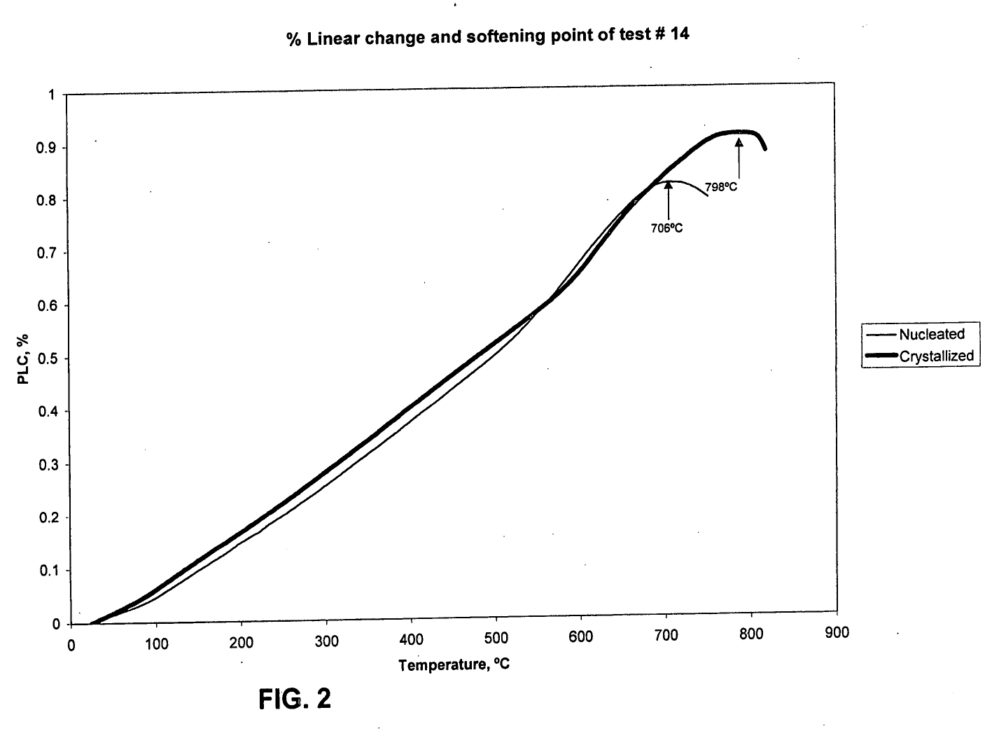

### DETAILED DESCRIPTION OF PREFERRED EMBODIMENTS

Unlike prior art materials which are based on the formation of lithium disilicate materials, an object of the present invention is to prepare a controlled nucleated lithium silicate glass ceramic with excellent machining properties. Then by heat treatment a complete crystal growth is achieved forming a glass ceramic product with outstanding mechanical properties, excellent optical properties, a very good chemical solubility, little contraction, and high flexural strength. We found that the use of germanium oxide creates several advantages for this formula and process compared to existing lithium disilicate materials. One such advantage is a low viscosity of the melt during the firing process that improves the castability of the material. Another advantage is a higher final density (10% higher than regular lithium disilicate material) that improves flexural strength. The final translucency is almost as good as that of the GeO2 free glass ceramic.

The lithium silicate of the present invention comprises the following components and compositions:

TABLE I

| COMPONENT | MIN | MAX |
|---|---|---|
| SiO₂ | 53.0 | 59.0 |
| Al₂O₃ | 2.5 | 4.2 |
| K₂O | 3.5 | 4.5 |
| CeO₂ | 0 | 2.0 |
| Li₂O | 14.0 | 16.0 |
| ZrO₂ | 2.5 | 6.0 |
| TiO₂ | 0.3 | 1.8 |
| P₂O₅ | 2.7 | 4.0 |
| Er₂O₃ | 0 | 2.0 |
| F | 0 | 1.0 |
| V₂O₅ | 0 | 1.0 |
| CaO | 0 | 2.0 |
| GeO2 | 0 | 8.4 |
| MgO | 0 | 2.0 |
| MnO₂ | 0 | 1.0 |
| Ta₂O₅ | 0 | 1.0 |
| Pr₂O₃ | 0 | 1.0 |
| SnO | 0 | 1.0 |
| Nb₂O₅ | 0 | 1.0 |
| Sm₂O₃ | 0 | 6.0 |
| Eu₂O₃ | 0 | 1.0 |
| Y₂O₃ | 0 | 3.0 |
| Tb₄O₇ | 0 | 1.0 |

The invention is explained in more detail below with the following examples:

The sample preparation and its elemental oxide composition are listed in the Table II.

TABLE II
Components % weight

| | TEST | TEST | TEST | TEST | TEST | TEST | TEST | TEST |
|---|---|---|---|---|---|---|---|---|
| | #1 | #2 | #3 | #4 | #5 | #6 | #7 | #8 |
| SiO2 | 56.40 | 57.89 | 56.46 | 55.88 | 55.88 | 56.15 | 56.15 | 55.88 |
| Al2O3 | 3.26 | 3.15 | 3.26 | 3.22 | 3.22 | 3.24 | 3.24 | 3.22 |
| K2O | 3.61 | 4.10 | 3.61 | 3.57 | 3.57 | 3.59 | 3.59 | 3.57 |
| CaO | | | | | | | | |
| CeO2 | 0.93 | 1.80 | 0.93 | 0.92 | 0.92 | 0.93 | 0.93 | 0.92 |
| MgO | | | | | | | | |
| Fluorine | | | | | | | | |
| Li2O | 15.49 | 12.38 | 15.50 | 15.33 | 15.33 | 15.42 | 15.42 | 15.33 |
| ZrO2 | 5.11 | 2.53 | 5.11 | 5.06 | 5.06 | 5.09 | 5.09 | 5.06 |
| TiO2 | 0.62 | 0.60 | 0.62 | 0.61 | 0.61 | 0.62 | 0.62 | 0.61 |
| P2O5 | 3.07 | 3.71 | 3.08 | 3.04 | 3.04 | 3.06 | 3.06 | 3.04 |
| Cs2O | | | | | | | | |
| SnO | | | | | | | | |
| Er2O3 | 0.10 | 0.37 | 0.64 | 0.51 | 0.51 | 0.51 | 0.51 | 0.25 |
| V2O5 | 0.12 | 0.12 | 0.12 | 0.12 | 0.12 | 0.12 | 0.12 | 0.25 |
| GeO2 | 8.10 | 7.83 | 8.11 | 8.03 | 8.03 | 8.07 | 8.07 | 8.03 |
| MnO2 | | | | | | | | |
| Tb4O7 | | | | 0.51 | 0.51 | 1.28 | 1.28 | 0.00 |
| Ta2O5 | | | | | | | | |
| Dy2O3 | | | | | | | | |
| Pr2O3 | | 2.41 | | | | | | |
| Sm2O4 | 3.20 | 3.10 | 2.56 | 3.19 | 3.19 | 1.92 | 1.92 | 3.83 |
| Eu2O3 | | | | | | | | |
| Y2O3 | | | | | | | | |
| Nb2O5 | | | | | | | | |
| TOTAL | 100.00 | 100.00 | 100.00 | 100.00 | 100.00 | 100.00 | 100.00 | 100.00 |

| | TEST | TEST | TEST | TEST | TEST | TEST | TEST | TEST |
|---|---|---|---|---|---|---|---|---|
| | #9 | #10 | #11 | #12 | #13 | #14 | #15 | #16 |
| SiO2 | 55.88 | 55.62 | 55.88 | 55.84 | 55.87 | 55.87 | 55.76 | 55.83 |
| Al2O3 | 3.22 | 2.97 | 3.23 | 3.22 | 3.22 | 3.22 | 3.22 | 3.22 |
| K2O | 3.57 | 3.56 | 3.57 | 3.57 | 3.57 | 3.57 | 3.56 | 3.57 |
| CaO | | | | | | | | |
| CeO2 | 0.92 | 0.92 | 0.92 | 0.92 | 0.92 | 0.92 | 0.92 | 0.92 |
| MgO | | | | | | | | |
| Fluorine | | | | | | | | |
| Li2O | 15.33 | 15.27 | 15.34 | 15.33 | 15.33 | 15.33 | 15.30 | 15.32 |
| ZrO2 | 5.06 | 6.02 | 5.06 | 5.06 | 5.06 | 5.06 | 5.05 | 5.06 |
| TiO2 | 0.61 | 0.61 | 0.61 | 0.61 | 0.61 | 0.61 | 0.61 | 0.61 |
| P2O5 | 3.04 | 2.65 | 3.04 | 3.04 | 3.04 | 3.04 | 3.04 | 3.04 |
| SnO | | | | | | | | |
| Er2O3 | 0.25 | | | | 0.03 | 0.03 | 0.10 | 0.12 |
| V2O5 | 0.25 | | | 0.06 | 0.03 | 0.03 | 0.07 | |
| GeO2 | 8.03 | 7.99 | 8.03 | 8.02 | 8.03 | 8.03 | 8.01 | 8.02 |
| MnO2 | | | 0.00 | | | | | |
| Tb4O7 | 0.00 | | | | | | 0.07 | |
| Ta2O5 | | | | | | | | |
| Dy2O3 | | | | | | | | |
| Pr2O3 | | | | | | | | |
| Sm2O4 | 3.83 | 4.39 | 4.32 | 4.32 | 4.28 | 4.28 | 4.28 | 4.28 |
| Eu2O3 | | | | | | | | |
| Y2O3 | | | | | | | | |
| Nb2O5 | | | | | | | | |
| TOTAL | 100.00 | 100.00 | 100.00 | 100.00 | 100.00 | 100.00 | 100.00 | 100.00 |
| | TEST | TEST | TEST | TEST | TEST | TEST | TEST | TEST |
| | #17 | #18 | #19 | #20 | #21 | #22 | #23 | #24 |
| SiO2 | 55.71 | 55.83 | 56.02 | 58.19 | 55.62 | 54.26 | 57.75 | 56.60 |
| Al2O3 | 3.22 | 3.22 | 3.23 | 3.36 | 3.21 | 2.51 | 3.33 | 3.27 |
| K2O | 3.56 | 3.57 | 3.90 | 3.73 | 3.56 | 3.48 | 3.69 | 3.62 |
| CaO | | | | | | | | |
| CeO2 | 0.92 | 0.92 | | 0.87 | 0.83 | | 0.95 | 0.93 |
| MgO | | | | | 0.00 | 1.20 | | |
| Fluorine | | | | | | | | |
| Li2O | 15.29 | 15.32 | 15.37 | 15.97 | 15.26 | 14.42 | 15.85 | 15.54 |
| ZrO2 | 5.05 | 5.06 | 5.07 | 5.27 | 5.03 | 4.92 | 5.23 | 5.13 |
| TiO2 | 0.61 | 0.61 | 0.61 | 0.63 | 0.60 | 1.79 | 0.63 | 0.62 |
| P2O5 | 3.04 | 3.04 | 3.34 | 3.17 | 3.03 | 3.87 | 3.14 | 3.08 |
| SnO | | | | | | | | |
| Er2O3 | 0.32 | | | | | 0.12 | 0.28 | 0.12 |
| V2O5 | | 0.12 | 0.12 | 0.45 | 0.43 | 0.06 | 0.21 | 0.10 |
| GeO2 | 8.00 | 8.02 | 8.05 | 8.36 | 8.00 | 7.81 | 8.30 | 8.13 |
| MnO2 | | | | | | 0.05 | 0.21 | 0.10 |
| Tb4O7 | | | | | | | 0.43 | 0.19 |
| Ta2O5 | | | | | | | | |
| Dy2O3 | | | | | | | | |
| Pr2O3 | | | | | | | | |
| Sm2O4 | 4.28 | 4.28 | 4.29 | 0.00 | 4.43 | 4.33 | 0.00 | 2.56 |
| Eu2O3 | | | | | | | | |
| Y2O3 | | | | | | | | |
| Nb2O5 | | | | | | | | |
| TOTAL | 100.00 | 100.00 | 100.00 | 100.00 | 100.00 | 100.00 | 100.00 | 100.00 |

| | TEST | TEST | TEST | TEST | TEST | TEST | TEST |
|---|---|---|---|---|---|---|---|
| | #25 | #26 | #27 | #28 | #29 | #30 | #31 |
| SiO2 | 55.32 | 54.22 | 53.89 | 53.93 | 54.08 | 54.49 | 54.34 |
| Al2O3 | 3.20 | 3.13 | 3.11 | 3.11 | 3.12 | 3.86 | 3.84 |
| K2O | 3.54 | 3.46 | 3.44 | 3.44 | 3.45 | 4.20 | 4.18 |
| CaO | | | | | | | |
| CeO2 | 0.91 | 0.63 | 0.63 | 0.63 | 0.95 | 0.64 | 0.64 |
| MgO | | | | | | | |
| Fluorine | | | | | | | |
| Li2O | 15.19 | 14.89 | 14.80 | 14.81 | 14.85 | 15.25 | 15.20 |
| ZrO2 | 5.02 | 4.91 | 4.88 | 4.88 | 4.89 | 4.88 | 4.86 |
| TiO2 | 1.72 | 0.63 | 0.63 | 0.63 | 0.63 | 0.64 | 0.64 |
| P2O5 | 3.02 | 2.95 | 2.93 | 2.94 | 2.95 | 2.97 | 2.96 |
| Cs2O | | | | | | | |
| SnO | | | | | | | |
| Er2O3 | 0.13 | 0.38 | 0.95 | 1.26 | 1.52 | 1.28 | 1.28 |
| V2O5 | 0.05 | 0.03 | 0.03 | 0.03 | 0.06 | 0.04 | 0.03 |
| GeO2 | 7.96 | 7.79 | 7.75 | 7.75 | 7.77 | 7.70 | 7.67 |
| MnO2 | 0.06 | | | | | | |
| Tb4O7 | 0.09 | | | | | | |
| Ta2O5 | | | | | | | |
| Dy2O3 | | | | | | | |
| Pr2O3 | | 1.27 | 1.26 | 0.88 | 0.88 | 0.72 | 1.02 |
| Sm2O4 | 3.79 | 5.71 | 5.70 | 5.71 | 4.82 | 3.34 | 3.33 |
| Eu2O3 | | | | | | | |
| Y2O3 | | | | | | | |
| Nb2O5 | | | | | | | |
| TOTAL | 100.00 | 100.00 | 100.00 | 100.00 | 100.00 | 100.00 | 100.00 |

| | TEST | TEST | TEST | TEST | TEST | TEST | TEST | TEST |
|---|---|---|---|---|---|---|---|---|
| | #32 | #33 | #34 | #35 | #36 | #37 | #38 | #39 |
| SiO2 | 57.67 | 57.00 | 57.55 | 57.86 | 57.86 | 57.67 | 57.83 | 57.62 |
| Al2O3 | 4.08 | 4.02 | 4.06 | 4.09 | 4.09 | 4.07 | 4.08 | 4.07 |
| K2O | 4.45 | 4.40 | 4.43 | 4.45 | 4.45 | 4.44 | 4.45 | 4.44 |
| CaO | 0.44 | 0.44 | 0.44 | 0.45 | 0.45 | 0.44 | 0.45 | 0.44 |
| CeO2 | 0.51 | 0.51 | 0.58 | 0.58 | 0.72 | 1.24 | 1.38 | 0.57 |
| MgO | 0.22 | 0.22 | 0.22 | 0.23 | 0.23 | 0.22 | 0.23 | 0.22 |
| Fluorine | 0.50 | 0.49 | 0.50 | 0.50 | 0.50 | 0.50 | 0.50 | 0.50 |
| Li2O | 15.94 | 15.75 | 15.91 | 16.00 | 16.00 | 15.94 | 15.98 | 15.92 |
| ZrO2 | 5.14 | 5.08 | 5.13 | 5.15 | 5.15 | 5.14 | 5.15 | 5.13 |
| TiO2 | 1.03 | 1.03 | 1.03 | 0.51 | 0.59 | 0.84 | 0.71 | 0.73 |
| P2O5 | 2.94 | 2.91 | 2.93 | 2.95 | 2.95 | 2.94 | 2.95 | 2.94 |
| Cs2O | | | | | | | | |
| SnO | 0.18 | 0.18 | 0.18 | 0.18 | 0.18 | 0.14 | 0.09 | 0.14 |
| Er2O3 | 0.25 | 0.25 | 0.32 | 0.32 | 0.24 | 0.31 | 0.27 | 0.10 |
| V2O5 | | | | | | | | |
| GeO2 | 0.91 | 2.00 | 0.91 | 0.92 | 0.92 | 0.91 | 0.92 | 0.91 |
| MnO2 | | | | | | | | |
| Tb4O7 | | | | | | | | |
| Ta2O5 | 0.25 | 0.25 | 0.25 | 0.25 | 0.28 | 0.32 | 0.28 | 1.05 |
| Dy2O3 | | | | | | | | |
| Pr2O3 | | | | | | | | |
| Sm2O4 | 2.59 | 2.58 | 2.59 | 2.59 | 2.50 | 2.42 | 2.49 | 2.37 |
| Eu2O3 | 0.06 | 0.06 | 0.06 | 0.06 | 0.06 | 0.06 | 0.06 | 0.06 |
| Y2O3 | 2.59 | 2.58 | 2.59 | 2.59 | 2.59 | 2.37 | 2.15 | 2.33 |
| Nb2O5 | 0.25 | 0.25 | 0.32 | 0.32 | 0.24 | 0.02 | 0.02 | 0.45 |
| TOTAL | 100.00 | 100.00 | 100.00 | 100.00 | 100.0 | 100.00 | 100.00 | 100.00 |

A lithium silicate material as described above that is particularly preferred, comprises 53 to 59 wt % of SiO2, 14 to 19% wt of Li2O and 1 to 9% of GeO2, where after nucleation only lithium silicate is formed and then after complete crystallization only lithium silicate crystals are formed.

The lithium silicate material is produced by a process which comprises the following steps:
(a) A mix of the precursors of the final components of the table 1, are blended together for 10 to 15 min until a mechanical mix is obtained.
(b) The mix is ball milled dry or wet using zirconia media for about 1 to 2 hours to homogenize the components and achieve almost the same particle size in all the components.
(c) The sample is melted for about 1 to 5 hours at a temperature of 1400 to 1500° C.
(d) The melt is poured in cylindrical or rectangular graphite molds and allowed to cool down to room temperature.
(e) The glass is subjected to a crystal nucleation process at a temperature of 630° to 650° C. for 10 to 40 min and the growth and size of the lithium silicate crystals are stopped temporally by cooling the glass ceramic to room temperature.
(f) For CAD-CAM milling device:
(g) The dental restoration is made using the previous pre-nucleated glass blocks and the restoration is crystallized to full crystal growth. The optimal lithium silicate crystal growth is achieved in a single step program from 350° to 830° C.
   For hot pressing:
   The ingot is nucleated or fully crystallized and then pressed at a temperature of 800-870° C.

The coloring of the glass ceramic is obtained by mixing the rare earth oxides in specific amounts for obtaining highly esthetic dental restorations.

### Coefficient of Thermal Expansion and Softening Point

The percentage linear change vs. temperature was measured using an Orton dilatometer. The coefficient of thermal expansion at 500° C. and the softening point were calculated for all the samples. For this purpose a rectangular rod of approximately 2 inches long was cast and then nucleated at 640° C. for 40 min. After this process the rod is cut into two parts. One part is used for measuring transition temperature, softening point temperature, and coefficient of thermal expansion of the nucleated phase. The second part is fully crystallized at 830 ° C. for about 10 minutes and is used for measuring the same properties. It is expected that after the crystallization step, the softening temperature point increases for the samples due to the formation of fully grown lithium silicate crystals.

### Flexural Strength.

Biaxial flexural strength tests (MPa) were conducted according to ISO-9693. Ten round samples were cut, grinded gradually and polished to a mirror finish in the nucleated stage. The samples were then fully crystallized in a single stage program from 350° C. to 830° C. for 10 minutes. Then the biaxial flexural strength was measured.

### Chemical Solubility.

A chemical solubility test was performed according to ISO-9693. Ten disc samples were placed in a glass flask with an aqueous solution of 4% (V/V) of acetic acid analytical grade (Alfa Aesar). The flask was heated to a temperature of 80±3° C. for 16 h. The weight change before and after the test was determined and then the chemical solubility expressed as μg/cm² was calculated and is shown in Table 2.

TABLE 2

| | TEST | TEST | TEST | TEST | TEST |
|---|---|---|---|---|---|
| | #3 | #19 | #23 | #25 | #36 |
| Softening temperature, ° C., | 702 | 739 | 766 | 762 | 661 |
| nucleated sample | | | | | |
| Softening temperature, ° C., | 826 | 810 | 789 | 794 | 830 |
| crystallized sample | | | | | |
| Coefficient of | 9.2 | 11.7 | 11.3 | 11.6 | 12.6 |
| expansion, ×10⁻⁶/° C. | | | | | |
| Crystallized sample | | | | | |
| Flexural strength, MPa, | 137 | 113 | 99 | 99 | 145 |
| Nucleated sample | | | | | |
| Flexural strength, MPa | 310 | 340 | 320 | 305 | 370 |
| Crystallized sample | | | | | |
| Chemical Solubility, .μg/cm² | 48 | 66 | 39 | 11 | 55 |
| Crystallized sample.μg/cm 2 | | | | | |

We found that the use of germanium creates several advantages for this new formula and process compared to existing lithium disilicate materials:

One such advantage is a low viscosity of the melt during the firing process, which improves the castability of the material.

Another advantage is a higher final density, at least 10% higher than regular lithium disilicate material, which improves flexural strength.

The preferred range composition (in % wt) of this glass ceramic material is the following:

TABLE 5
Preferred Range of Composition Components

| Component | MIN | MAX |
|---|---|---|
| SiO2 | 53.9 | 58.2 |
| Al2O3 | 2.5 | 4.1 |
| K2O | 3.4 | 4.5 |
| CaO | 0.4 | 0.5 |
| CeO2 | 0.5 | 1.8 |
| MgO | 0.0 | 1.2 |
| Fluorine | 0.0 | 0.5 |
| Li2O | 12.4 | 16.0 |
| ZrO2 | 2.5 | 6.0 |
| TiO2 | 0.5 | 1.8 |
| P2O5 | 2.7 | 3.9 |
| SnO | 0.1 | 0.2 |
| Er2O3 | 0.0 | 1.5 |
| V2O5 | 0.0 | 0.5 |
| GeO2 | 0.5 | 8.4 |
| MnO2 | 0.0 | 0.2 |
| Tb4O7 | 0.0 | 1.3 |
| Ta2O5 | 0.3 | 1.1 |
| Pr2O3 | 0.7 | 2.4 |
| Sm2O4 | 0.0 | 5.7 |
| Eu2O3 | 0.1 | 0.1 |
| Y2O3 | 2.2 | 2.6 |
| Nb2O5 | 0.0 | 0.5 |

One preferred example of this material has the following specific composition:

TABLE 6
PREFERRED COMPOSITION

| Component | Weight % |
|---|---|
| SiO₂ | 57.8 |
| Li₂O | 16.0 |
| GeO₂ | 1.00 |
| Al₂O₃ | 4.08 |
| K₂O | 4.45 |
| P₂O₅ | 2.95 |
| F | 0.50 |
| CaO | 0.45 |
| TiO₂ | 0.71 |
| ZrO₂ | 5.15 |
| CeO₂ | 1.38 |
| MgO | 0.23 |
| Coloring oxides | 5.30 |

Having thus disclosed a number of embodiments of the formulation of the present invention, including a preferred range of components and a preferred formula thereof, those having skill in the relevant arts will now perceive various modifications and additions. Therefore, the scope hereof is to be limited only by the appended claims and their equivalents.

We claim:

1. A lithium silicate ceramic glass made from a composition mixture comprising:
up to about 59% wt SiO2;
up to about 20% wt Li₂O
up to about 10% wt GeO₂;
and selected amounts %wt of at least Al₂O₃, K₂O, B₂O₃, CaO, F, MgO,CeO₂ and P₂O₅.

2. The lithium silicate ceramic glass recited in claim 1 wherein said composition mixture also comprises one or more of the following components: ZrO₂, TiO₂, Er₂O₃, V₂O₅, MnO₂, Tb₄O₇, Ta₂O₅, Sm₂O₃, Pr₂O₃, Y₂O₃, Nb₃O₅, SnO, and Eu₂O₃.

3. A lithium silicate ceramic glass made from a composition mixture comprising:
about 58.2% wt SiO₂;
about 16.0% wt Li₂O;
about 4.5% wt K₂O; and
about 4.5% wt of Al₂O₃; and
about 8.4% wt GeO₂.

4. The lithium silicate ceramic glass recited in claim 3 wherein said composition mixture also comprises at least 2.5% wt of each of the following components: P₂O₅, ZrO₂, CeO₂, Pr₂O₃, Y₂O₃, and Sm₂O₃.

5. The lithium silicate ceramic glass recited in claim 4 further comprising one or more of the following additional components: TiO₂, SnO, Eu₂O₃, Er₂O₃, Nb₂O₃ and V₂O₅.

6. The lithium silicate glass ceramic recited in claim 1 comprising a molar ratio of (SiO₂+GeO₂)/Li₂O between 1.7 and 2.5.

7. A method of fabricating dental restorations of lithium silicate glass; the method comprising the steps of:
(a) blending a mix of precursors;
(b) ball milling the mix to homogenize components of the mix;
(c) melting the resulting mix of step (b) for about 1 to 5 hours at a temperature of 1400 to 1500° C.;
(d) pouring the melt of step (c) into graphite molds to form shaped blanks and cooling such blanks to room temperature;
(e) heating the blanks of step (d) at a temperature of 630° to 650° C. for 10 to 40 min;
(f) milling the blanks of step (e) into dental restorations; and
(g) heating the restoration of step (f) at temperature of 350° to 830° C.

8. A method of fabricating dental restorations of lithium silicate glass; the method comprising the steps of:
(a) blending a mix of precursors;
(b) ball milling the mix to homogenize components of the mix;
(c) melting the resulting mix of step (b) for about 1 to 5 hours at a temperature of 1400 to 1500° C.;
(d) pouring the melt of step (c) into graphite molds to form shaped blanks and cooling such blanks to room temperature;
(e) heating the blanks of step (d) at a temperature of 630° to 650° C. for 10 to 40 min;
(f) hot pressing the blanks of step (e) into dental restorations at a temperature of 800° to 870° C.

9. The method of claim 7 wherein one of said precursors in step (a) is germanium oxide.

10. The method of claim 8 wherein one of said precursors in step (a) is germanium oxide.
